(19) United States
(12) Patent Application Publication
(10) Pub. No.: US 2024/0394483 A1
(43) Pub. Date: Nov. 28, 2024

(54) INSIGHTS SERVICE FOR LARGE LANGUAGE MODEL PROMPTING

(71) Applicant: Microsoft Technology Licensing, LLC, Redmond, WA (US)

(72) Inventors: Michael THOLFSEN, Newcastle, WA (US); Emma Margaret GRAY, Vancouver (CA); Ella BEN TOV, Tel-Aviv (IL); Shay BEN-ELAZAR, Herzliya (IL)

(21) Appl. No.: 18/506,766

(22) Filed: Nov. 10, 2023

Related U.S. Application Data
(60) Provisional application No. 63/504,024, filed on May 24, 2023.

(51) Int. Cl. G06F 40/40; G06Q 10/0639

(52) U.S. Cl. CPC G06F 40/40; G06Q 10/06395

(57) ABSTRACT

Systems and methods are provided herein for operating an insights service. For example, a method of operating an insights service includes observing, on a per-user basis with respect to each user in a group of observed users, the prompting associated with a large language model service, identifying, on the per-user basis with respect to each of the group of observed users, insights into the prompting, and enabling display of the insights in a user interface associated with a reviewing user.

### CROSS-REFERENCE TO RELATED APPLICATIONS

This patent application claims priority to and the benefit of U.S. Provisional Patent Application No. 63/504,024 filed on May 24, 2023, that is hereby incorporated by reference as if set forth in its entirety.

### TECHNICAL FIELD

Aspects of this disclosure are related to the field of computer software applications and services and, in particular, to large language model prompting and insights.

### BACKGROUND

Recent advances in computing and communication technologies have resulted in the introduction of powerful large language models (LLMs) into the everyday stream of online experiences. LLMs have been integrated into numerous environments such as search, content creation, and gaming. Users interact with LLMs in a conversational manner by submitting prompts that elicit responses from an LLM. In a search engine example, a user searches for a particular topic of interest and the search engine returns results. The user may also engage with an LLM-powered chatbot to obtain a more meaningful explanation of the results. For instance, a user may engage with an LLM-powered chatbot to obtain a summary of the results in a conversational manner that invites follow-up conversation between the user and the chatbot.

The quality of a user's experience with an LLM is dependent upon many factors, not the least of which is the quality of the user's prompting. Prompting is the act of generating and submitting inputs or queries to an LLM or other artificial intelligence (AI) model to elicit a specific response from the LLM or AI model. The prompts themselves may be natural language statements or questions, code snippets, or the like, that a user generates independently or with the assistance of prompting tools embedded in the user experience.

As LLM and other generative AI-powered tools advance and become ubiquitous in the workplace and schools, users who lack proficiency with respect to prompting are at risk of falling behind in their careers and education. In addition, ineffective prompts can produce results that are too scattered or unfocused to be of much use to a user. Indeed, it is common for users to repeatedly redo their prompts in an effort to elicit better results, resulting in a waste of time on their part, and a waste of resources on a global scale with respect to the compute resources needed to perform the searches. Many LLM and generative AI engines also enforce token limits on conversations, further driving the demand for prompting proficiency.

### SUMMARY

Technology disclosed herein includes software applications and services that provide insights into prompting conducted by users with respect to content generators, such as a large language model (LLM) or generative AI service. For example, a method of operating an insights service is provided herein. Such method of operating an insights service includes observing, on a per-user basis with respect to each user in a group of observed users, the prompting associated with a large language model service, identifying, on the per-user basis with respect to each of the group of observed users, insights into the prompting, and enabling display of the insights in a user interface associated with a reviewing user.

In various implementations, observing the prompting includes observing prompts submitted to the large language model service, observing replies to the prompts from the large language model service, and observing user actions with respect to the replies. The method may also include organizing the prompting into conversations, classifying each of the conversations as belonging to one or more of a set of categories based at least on characteristics of the prompts, characteristics of the replies, and characteristics of the user actions, and identifying trends with respect to the set of categories.

In the same or other implementations, the categories may include a subset of categories associated with prompting types, such as a creative category, a productivity category, a learning category, and a research category. In the same or other implementations, the categories may include a subset of categories associated with prompting topics, such as an off-task category, an on-task category, and an inappropriate content category. In the same or other implementations, the categories may include a subset of categories associated with prompting quality, such as a high-quality category and a low-quality category.

The characteristics of the prompts may include content of the prompts, while the characteristics of the replies may include content of the replies. Characteristics of the user actions may include dwell time over the replies, a frequency of using a stop-replying feature with respect to the replies, and a frequency of click-throughs with respect to the content in the replies.

This Summary is provided to introduce a selection of concepts in a simplified form that are further described below in the Technical Disclosure. It may be understood that this Overview is not intended to identify key features or essential features of the claimed subject matter, nor is it intended to be used to limit the scope of the claimed subject matter.

### BRIEF DESCRIPTION OF THE DRAWINGS

Many aspects of the disclosure may be better understood with reference to the following drawings. The components in the drawings are not necessarily to scale, emphasis instead being placed upon clearly illustrating the principles of the present disclosure. Moreover, in the drawings, like reference numerals designate corresponding parts throughout the several views. While several embodiments are described in connection with these drawings, the disclosure is not limited to the embodiments disclosed herein. On the contrary, the intent is to cover all alternatives, modifications, and equivalents.

FIG. 1 illustrates an operational environment in an implementation.

FIG. 2 illustrates an insights process in an implementation.

FIG. 3 illustrates an operational scenario in an implementation.

FIG. 4 illustrates an operational environment in an implementation.

FIGS. 5A-5H illustrate a user experience in an implementation.

FIG. 6 illustrates a computing system suitable for implementing the various operational environments, architectures, processes, scenarios, and sequences discussed below with respect to the other Figures.

### DETAILED DESCRIPTION

Technology disclosed herein is generally directed to providing insights for visualizing prompting progress across individuals and groups, such as students and workforce personnel. Prompting trends of individuals and/or groups are displayed, e.g., to an instructor, who receives a holistic view of prompting activities. Providing the insights allows an instructor to coach an end user (or allows individuals themselves to learn) to engage the full capabilities of generative AI, in particular, large language models (LLMs) more proficiently. For case of explanation, the following discussion relates to LLMs, however, it should be appreciated that other generative AI models, such as Stable Diffusion™ or DALL-E, are equally applicable. These generative models may have a single mode of interaction (e.g., text, images) or they may be multimodal, accommodating multiple modes of input and/or output.

In various implementations, a software application on a computing device communicates with an online service to obtain insight information indicative of the progress (or lack thereof) of users with respect to prompting. The application displays the insights in a manner that allows a user to review progress of the group as a whole, as well as to drill-down into the data on a per-user basis. The user experience provided by the application allows a reviewing user to quickly and easily understand the progress that an individual user is making with respect to their proficiency when constructing prompts. Examples of reviewing users include teachers, managers, or other such personnel in reviewing positions. In some cases, a reviewing user may be in a supervisory position, although a reviewing user need not be a supervisor with respect to an observed user.

Various technical effects that result from the generation and delivery of prompt insights as disclosed herein may be apparent. At a high level, the insights provided to individual users form the basis for improved instruction with respect to prompting skills and techniques. The improved instruction, when applied to observed users, results in improved prompts. In turn, the improved prompts reduce search churn by eliciting improved replies. For example, the replies returned by an LLM engine may be more factual (less weighted towards opinion), more accurate (less misleading), and overall, of a higher quality than without such improvements.

In the aggregate, a reduction in human-computer conversational churn reduces the computing resources required of the LLM engines that process the prompts. A reduction in conversational churn may reduce demand on a global scale for the energy required to power modern LLM engines. At a more local level, reduced conversational churn consumes less battery power (e.g., on mobile devices) since fewer queries are needed, to say nothing of improving the basic user experience with respect to conversational AI. Improved prompting also reduces the time it takes a user to find and access relevant information, time which may be spent on other productive activities.

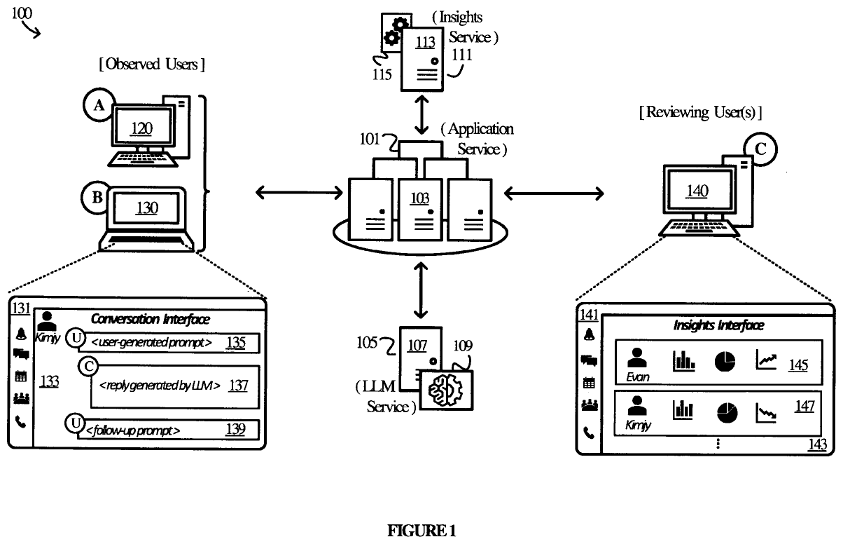

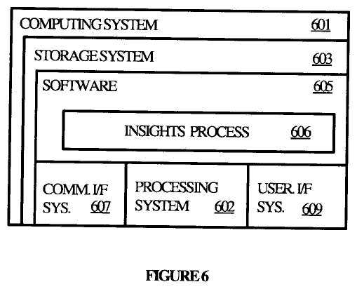

Referring now to FIG. 1, FIG. 1 illustrates an operational environment 100 in an implementation of insights for prompting proficiency. Operational environment 100 includes application service 101, LLM service 105, and insights service 111, as well as computing devices 120, 130 and 140. Application service 101 employs one or more server computers 103 co-located with respect to each other or distributed across one or more data centers. Example servers include web servers, application servers, virtual or physical servers, or any combination or variation thereof, of which computing device 601 in FIG. 6 is broadly representative.

Computing devices 120, 130, and 140 communicate with application service 101 via one or more internets and intranets, the Internet, wired and wireless networks, local area networks (LANs), wide area networks (WANs), or any other type of network or combination thereof. Examples of computing devices 120, 130, and 140 include personal computers, tablet computers, mobile phones, gaming consoles, wearable devices, Internet of Things (IoT) devices, and any other suitable devices, of which computing device 601 in FIG. 6 is also broadly representative.

Broadly speaking, application service 101 provides software application services to end points such as computing devices 120, 130, and 140, examples of which include productivity software for creating content (e.g., word processing, spreadsheets, and presentations), email software, and collaboration software. Computing devices 120, 130, and 140 load and execute software applications locally that interface with services and resources provided by application service 101. The applications may be natively installed and executed applications, web-based applications that execute in the context of a local browser application, mobile applications, streaming applications, or any other suitable type of application. Example services and resources provided by application service 101 include front-end servers, application servers, content storage services, authorization and authentication services, and the like.

Application service 101 includes an integration with an LLM service 105 to support conversational interactions between users and LLM-powered chatbots and other types of AI tools. LLM service 105 employs one or more server computers 107 co-located with respect to each other or distributed across one or more data centers, of which computing device 601 in FIG. 6 is broadly representative. LLM service 105 hosts LLM engine 109 on server computers 107. LLM engine 109 is representative of an LLM-powered artificial intelligence (AI) model capable of interacting in a conversational manner via prompts generated by users of other applications and services, and replies generated by the LLM engine in response to the prompts.

Application service 101 also includes an integration with insights service 111, which is capable of analyzing and reporting on the conversational interactions between users and LLM engine 109. Insights service 111 employs one or more server computers 113 co-located with respect to each other or distributed across one or more data centers, of which computing device 601 in FIG. 6 is broadly representative. Insights service 111 hosts insights engine 115 on server computers 113. Insights engine 115 is representative of analytics software capable of capturing the prompts and replies exchanged between user applications and LLM engine 109, analyzing the interactions, and providing insights about the users' prompting.

Application service 101 and insights service 111 provide insights to reviewing users with respect to the prompts constructed and submitted by observed users. Here, user A (associated with computing device 120) and user B (associated with computing device 130) are observed users, while user C (associated with computing device 140) is a reviewing user. Users A and B construct prompts in the context of software applications running on computing devices 120 and 130, respectively, while user C consumes the insights in the context of software running on computing device 140.

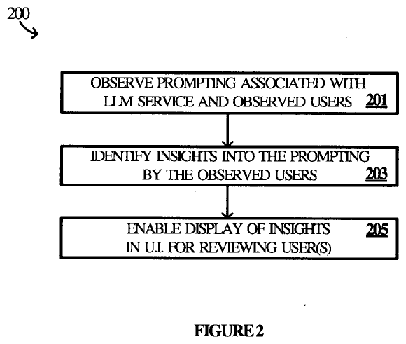

A technical improvement to such environments disclosed herein allows users in a supervisory position not only to observe the prompting capabilities of their supervisees, but also to obtain prompting-related insights about the supervisees that heretofore have not been available. In particular, FIG. 2 illustrates a process employed by application service 101 to collect prompting signals and supply prompting-related insights to users. The users may be, for example: observed users (those whose prompting is being observed) and reviewing users (those reviewing the progress of observed users). In some cases, the observed user and the reviewing user may be one in the same.

Turning to FIG. 2, insights process 200 is provided. Insights process 200 represents a method for generating and distributing prompting-related insights. Insights process 200 is implemented in program instructions in the context of a software application, service, micro-service, or combination thereof running on one or more computing devices. The program instructions direct the computing devices to operate as follows, referring to a computing device in the singular for the sake of simplicity.

To begin, a computing device implementing insights process 200 observes, on a per-user basis with respect to each user in a group of observed users, their prompting associated with a large language model service (step 201). Observing the prompting may include, for example, observing prompts submitted to the large language model service, as well as observing replies to the prompts from the large language model service. Observing the prompting may also include observing user actions with respect to the replies, such as click-throughs to links supplied in the replies (or other selections thereof), dwell time over the replies, and the like.

In some implementations, the computing device organizes the prompting into conversations and classifies the conversations as belonging to one or more of a set of categories based on characteristics of the prompts, replies, and user actions. The categories may include multiple subsets of categories, such as one associated with prompting types, one associated with prompting topics, and one associated with prompting quality. Categories associated with prompting types may include a creative category, a productivity category, a learning category, and a research category. For example, if the assignment is to draft an essay on what astronauts cat in space, then a prompt involving what astronauts eat in space depending on what planet they are near/on, may fall into the creative category. A prompt involving example menus of what astronauts currently on the International Space Station eat may fall into the productive category. A prompt involving why astronauts have to cat different types and forms of food while in orbit may fall into the learning category. And a prompt involving statistics on what food items are most commonly consumed by astronauts may fall into the research category.

As noted above, prompts may also be categorized by prompting topics. Categories associated with prompting topics may include an off-task category, an on-task category, and an inappropriate content category. Following the above example of an assignment involving food that astronauts eat in space, the on-task category of prompting may include prompts relating to astronaut food, while the off-task category prompting may include prompts not relating to the astronaut food (e.g., what team won the 1991 Stanely Cup). Finally, prompts that include inappropriate content, such as offensive, explicit, or hateful content, may fall into the inappropriate content category.

Additional categories may include those associated with the quality of the prompting. Categories associated with prompting quality may include a high-quality category and a low-quality category. For example, a high-quality prompt may include a prompt that provides multiple details on what is being requested, such as a length, topic, time duration, and the like. In contrast, a low-quality prompt may include a prompt that is short and lacks detail about what is being requested. Following the above example, a high-quality prompt may be “draft a paragraph on what astronauts who are currently living in the International Space Station are eating during their mission, including whether any of the astronauts have food restrictions.” In contrast, a low-quality prompt may be “what do astronauts eat?”

As noted above, the characteristics of the prompts may determine what category the prompting is assigned. Characteristics of the prompts include the content of the prompts, while characteristics of the replies include the content of the replies. As those skilled in the art appreciate, the content of the prompts includes the text (and/or image or other input in the case of a multimodal generative AI model) submitted to the LLM, such as the format (e.g., question or request), the topic of the prompt along with the content provided, and the format of the requested output (e.g., draft a paragraph, paper, email). Similarly, the content of the replies includes the format of the reply (e.g., text, image, sound depending on the type of generative AI service employed), the style of the reply (e.g., paragraph, email, list), and the context provided.

The characteristics of the user actions are also analyzed and used to categorize the prompts. Characteristics of the user actions include a dwell time over the replies, a frequency of using a stop-replying feature with respect to the replies, and/or a frequency of click-throughs or other selections with respect to the content of the replies.

Having observed the prompting, the computing device proceeds to identify, on the per-user basis with respect to each of the group of observed users, insights into the prompting (step 203). Example insights include statistics related to the classification categories such as counts, trends, and the like for each category or sub-category. Other insights include information flagging prompts that are not on-task or that are objectively inappropriate. The insights may include groupings of conversations by topic allowing a reviewer or observed user to click into a conversation to monitor or review an exchange. Other example insights include word clouds derived from the content in the prompts and replies. In some implementations, the insights may include citation analysis such as a rate of click-throughs to a resource cited in a reply.

As mentioned, the insights may relate to the classification categories, including prompting quality. For example, the insights may include a measure of dwell time by an observed user with respect to a reply provided by an LLM, as well as a dwell time by the user over content provided by a link in a reply. The insights may also include analysis with respect to how many traditional Internet searches turned into chat conversations with an LLM service.

Finally, the computing device enables display of the insights in a user interface associated with a reviewing user (step 205). Enabling display of the insights may include, for example, sending information indicative of the insights to a client device for display in a user interface associated with a reviewing user. The information may be sent in the context of a webpage, an image, or another object or collection of objects that may be rendered in a user interface on an end point. For instance, the insights may be displayed by a component of an application that includes an integrated insights tool or add-in application, or by a component of a dedicated application specific to insights. The reviewing user may navigate the user interface to consume insights on specific observed users or groups of users in order to provide them with coaching and instruction with respect to their prompting capabilities.

Referring back to FIG. 1, the following describes an application of insights process 200 with respect to the elements of operational environment 100. In operation, users A and B (observed users) may engage with LLM service 105 in a variety of ways including through conversational components of local applications running on computing devices 120 and 130, respectively. The proficiency of the users with respect to prompting may be monitored and evaluated by user C (a reviewing user) via an application or tool running on computing device 140. The users supply a natural language input in the form of typed text and/or spoken (audible) words that form the basis of a prompt to an LLM. As used herein, a natural language input may be text phrased in a user's natural language or everyday vernacular. LLM service 105 receives the prompt, processes it, and returns a reply that (presumably) addresses a request, task, or other such statement included in the prompt. The success of the prompt depends at least partly on the prompting proficiency of the user. That is, the relative skill of the user with respect to prompting will play a large role in whether the user's prompts elicit replies that are helpful, informative, and generally useful.

In the scenario illustrated in FIG. 1, user B engages with LLM service 105 via a user interface 131 to an application executing on computing device 130. User interface 131 includes a conversational interface 133 through which user B may construct and submit prompts to LLM service 105, as well as consume and interact with replies from LLM service 105. Conversational interface 133 includes input components 135 and 139 for receiving a natural language input from the user for generating the prompts. Conversational interface 133 also includes an output component 137, which is representative of components through which the application surfaces the replies from LLM service 105. While illustrated as a text-based interface, it may be appreciated that one or both of the inputs and outputs could be provided in accordance with a different modality such as speech, audio, or other modes of input and output.

User C engages with insights service via a user interface 141 to an application executing on computing device 140. User interface 141 includes an insights interface 143 through which user C may obtain and consume insights with respect to the prompting by user A and user B. Insights interface 143 includes components 145 and 147 that are representative of graphical user interface elements through which insights about prompting behavior may be displayed. For example, component 145 includes various charts and graphs that are representative of statistics, analysis, and other such information related to the prompting of user A (“Evan”), while component 147 includes the same with respect to user B (“Kimjy”).

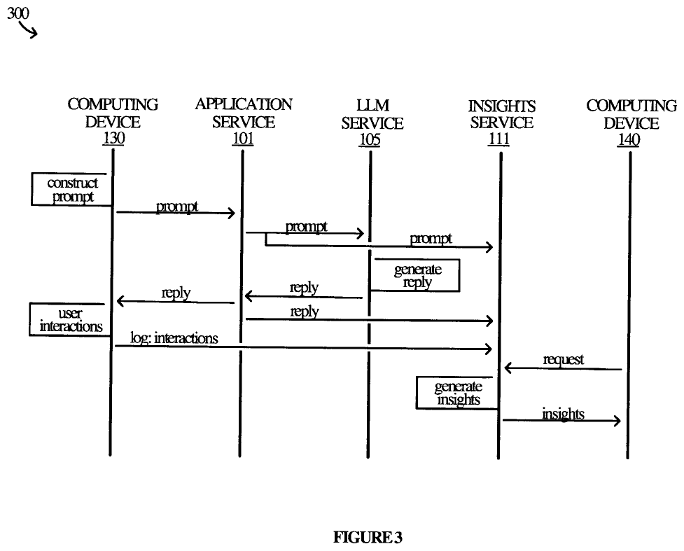

FIG. 3 illustrates a brief operational scenario 300 to further highlight an application of insights process 200 with respect to various components of operational environment 100. In operation, user B constructs a prompt via an application on computing device 130. The application sends the prompt to application service 101, which routes the prompt to LLM service 105. Application service 101 also sends a copy of the prompt to insights service 111. In some scenarios, the application on computing device 130 may send the prompt to one or both of LLM service 105 and insights service 111 directly, rather than via application service 101.

LLM service 105 receives the prompt, generates a reply, and returns the reply to computing device 130 either through application service 101 or directly to computing device 130. The application on computing device 130 displays the reply for user B's consideration, resulting in user interactions such as user B formulating a follow-up prompt, clicking on a link in the reply, or the like. The user's interactions are logged by the application on computing device 130 and communicated to insights service 111.

Insights service 111 processes the interactions to develop prompting insights about user B, which it supplies to an application on computing device 140 upon request, automatically, or at some other interval. For example, user C may navigate to a page that references user B, thereby triggering a request by user C's application to insights service 111 for insights about user B. Insights service 111 responsively generates the insights and delivers them to the application on computing device 140 for display to user C.

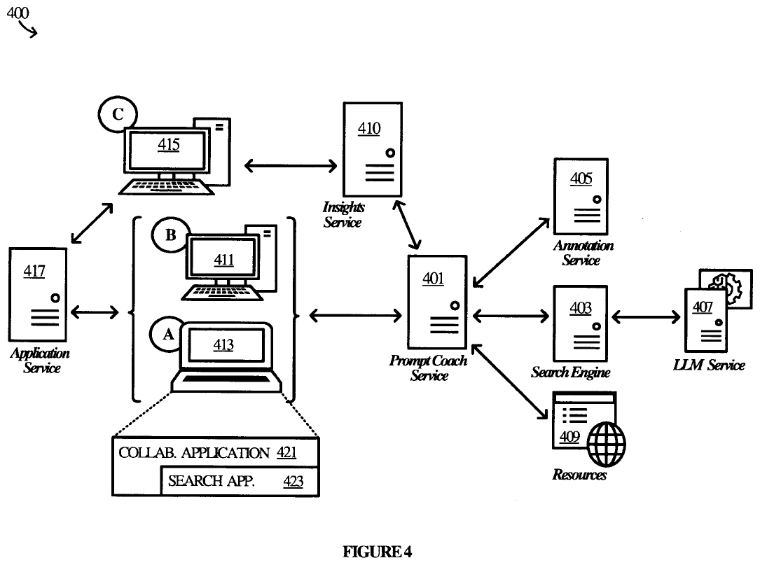

Referring now to FIG. 4, FIG. 4 illustrates operational environment 400 in another implementation of insights for LLM engine utilization. Operational environment 400 includes prompt coach service 401, search engine 403, annotation service 405, LLM service 407, insights service 410, and application service 417. Operational environment 400 also includes computing devices 411-415, which interface with one or more of the aforementioned components of the environment.

Prompt coach service 401, search engine 403, annotation service 405, and insights service 410 are each representative of software services, micro-services, or the like, implemented on one or more server computers co-located or distributed across one or more data centers connected to computing devices 411-415. Application service 417 is also representative of a software service, micro-service, or other such application implemented on one or more server computers co-located or distributed across one or more data centers connected to computing devices 411-415. Example servers include web servers, application servers, virtual or physical, or any combination or variation thereof, of which computing device 601 in FIG. 6 is again broadly representative.

Computing devices 411-415 communicate with one or more of prompt coach service 401, search engine 403, annotation service 405, LLM service 407, insights service 410, and application service 417 via one or more internets and intranets, the Internet, wired and wireless networks, LANs, WANs, or any other type of network or combination thereof. Examples of computing devices 411-415 include personal computers, tablet computers, mobile phones, gaming consoles, wearable devices, IoT devices, and any other suitable devices, of which computing device 601 in FIG. 6 is also broadly representative.

Prompt coach service 401 provides an interface through which search tools on computing devices 413 and 415 access search engine 403 and LLM service 407 to perform enhanced Internet searches that include chat-based integrations with LLM engines. For case of discussion, the following discussion is with reference to an assignment involving Internet searches, however, it should be appreciated that the following is equally applicable to other forms of prompting, such as prompting to engage with an operating system, productivity application, file system, and the like. In such cases, the operational system 400 may not include the prompt coach service 401. Instead, the prompt coach service 401 or the insight service 410 may directly communicate with the LLM service 407.

Returning now to the illustrative example, search engine 403 is representative of a search engine capable of indexing and searching web pages and other Internet resources 409 based on search queries generated by end points such as computing devices 413 and 415. Search engine 403 communicates with the LLM service 407, for example, by an integration with LLM service 407 that allows a user to enhance their search queries with chat-based interactions with an AI-powered LLM engine. For instance, a user can first search for key terms, then follow up the search with follow up questions and refinements in a chat format.

Annotation service 405 is representative of a service capable of annotating search results at the request of prompt coach service 401 to provide context with respect to the search results. For example, annotation service 405 may identify specific results as more or less reliable sources of the information being sought by a specific query. Annotation service 405 may also be capable of annotating LLM replies at the request of prompt coach service 401 to provide context with respect to chat replies provided by LLM service 407.

Insights service 410 is representative of a service capable of observing the usage of prompts by users, analyzing the usage and delivering relevant insights about their usage. Insights service 410 communicates with prompt coach service 401 either in-line or out-of-band with respect to prompts flowing through the service to obtain indications of the words, phrases, and other characteristics of the prompts being constructed and submitted to LLM service 407. For example, insights service 410 may obtain copies of the prompts, allowing insights service 410 to parse the prompts to identify their characteristics and classify them accordingly. Insights service 410 develops a record of prompt usage on a per-user basis that it may then leverage when developing prompting insights.

Application service 417 is representative of any application provided as a service that users may interface with via corresponding applications on their computing devices. Examples of application service 417 include—but are not limited to—collaboration services, communication services, productivity services, gaming services, and business application services. The local application(s) corresponding to application service 417 (e.g., a collaboration application, productivity application, or the like) are capable of hosting search-related applications in their execution contexts. Here, collaboration application 421 is representative of one such application that hosts a search application 423. An observed user may engage with collaboration application 421 to access its features and functionality. The user may also engage with search application 423—in the context of collaboration application 421—to access its features and functionality (i.e., those of search application 423).

In a brief example, an observed user may engage with collaboration application 421 to chat with other users, make voice or video calls to other users, join conference calls between multiple users, share documents, or otherwise collaborate. Such interactions may involve collaboration application 421 connecting to application service 417 and exchanging data with application service 417. At the same time, the observed user may engage with search application 423 to conduct Internet searches, view search results, and engage with an AI-powered chatbot to enhance the search experience.

Some reviewing users-such as a teacher, manager, or person in charge of a group—may experience search application 423 in a supervisory mode. In the supervisory mode, the reviewing user is provided with insights into the search and prompting habits, patterns, and proficiency of the users in the group.

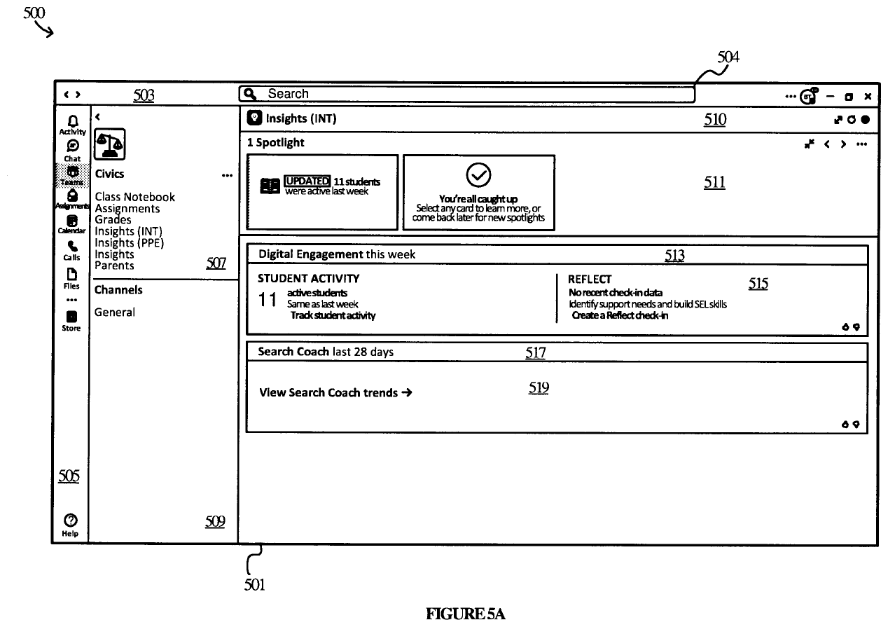

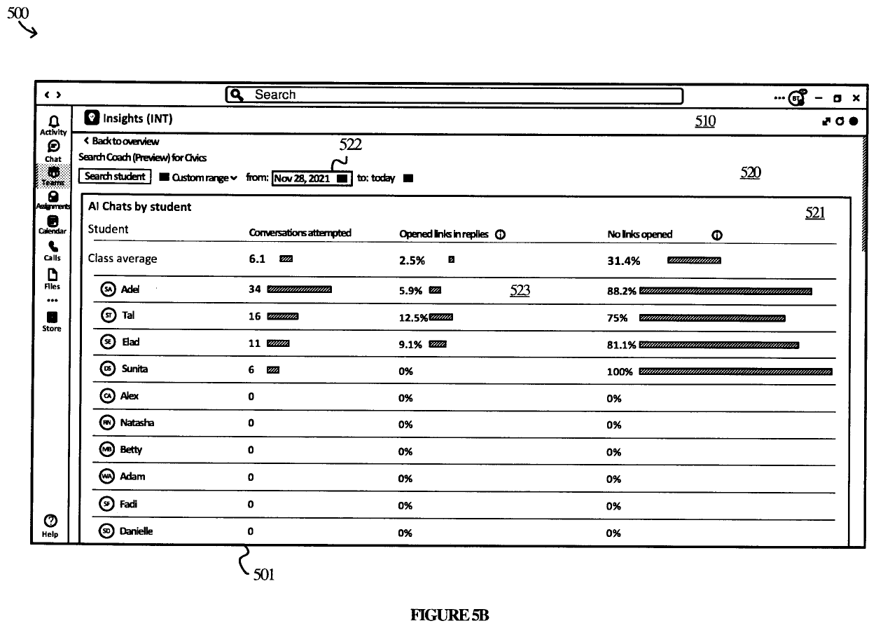

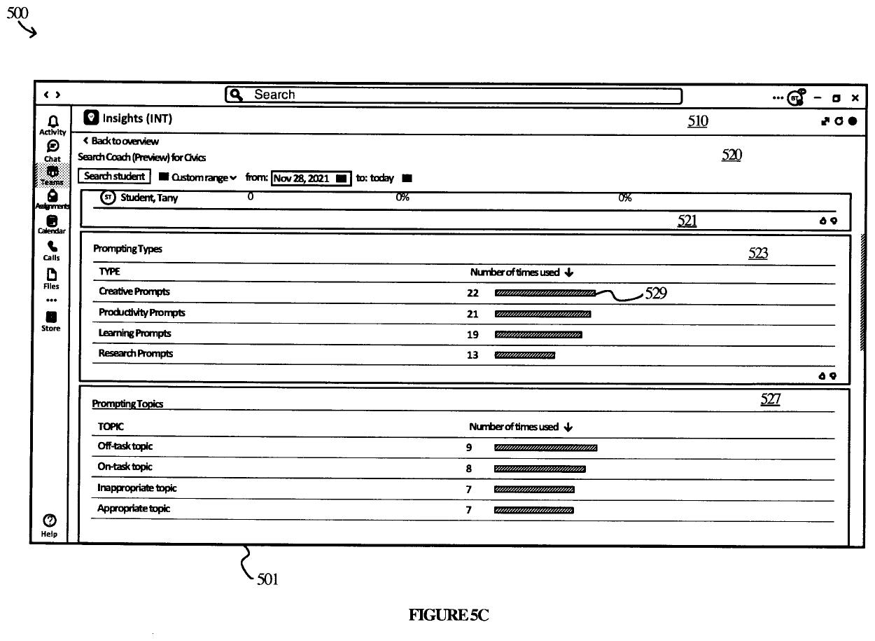

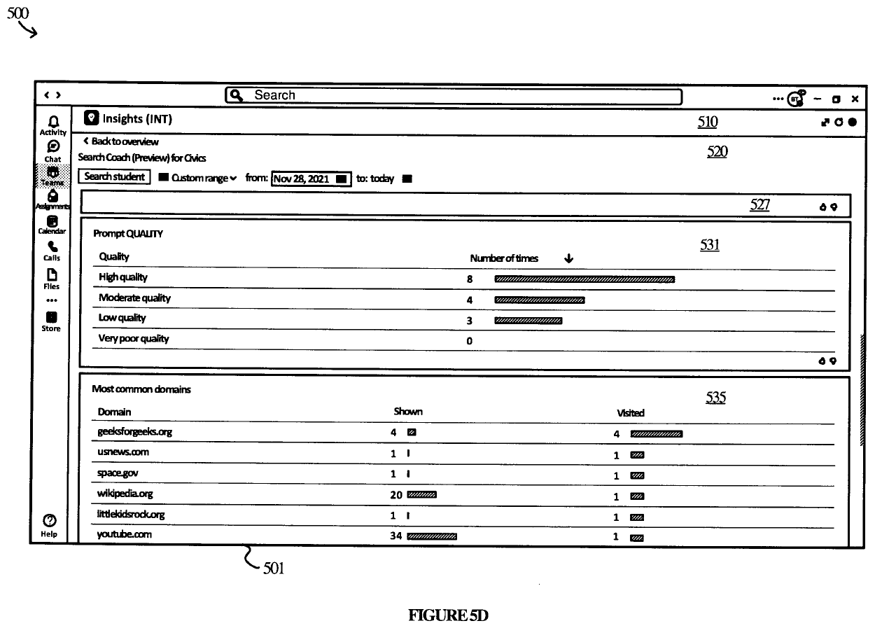

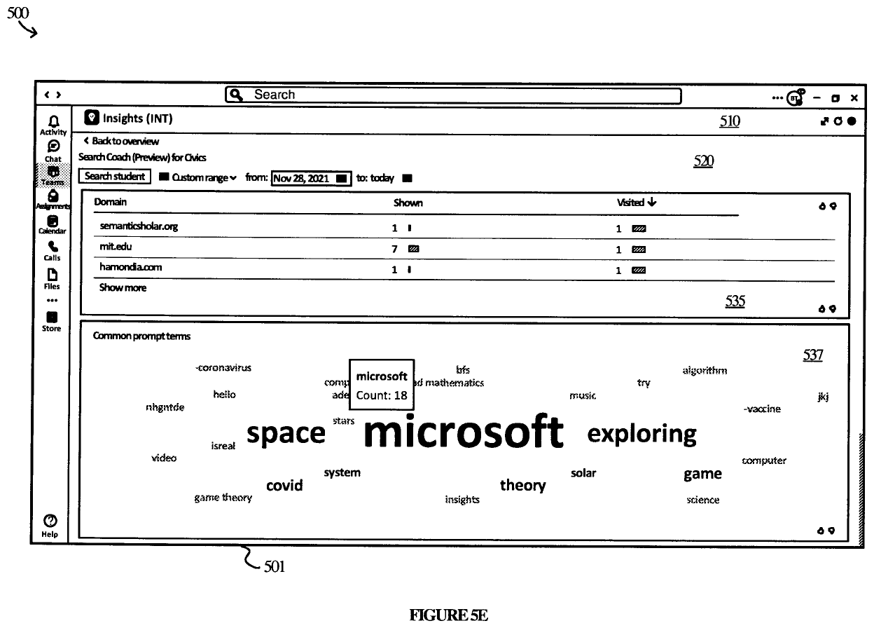

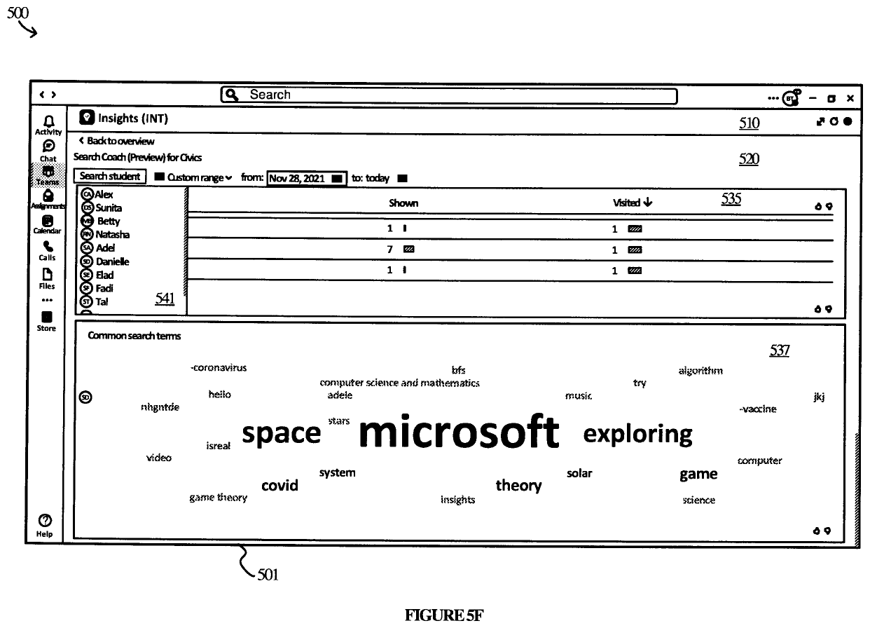

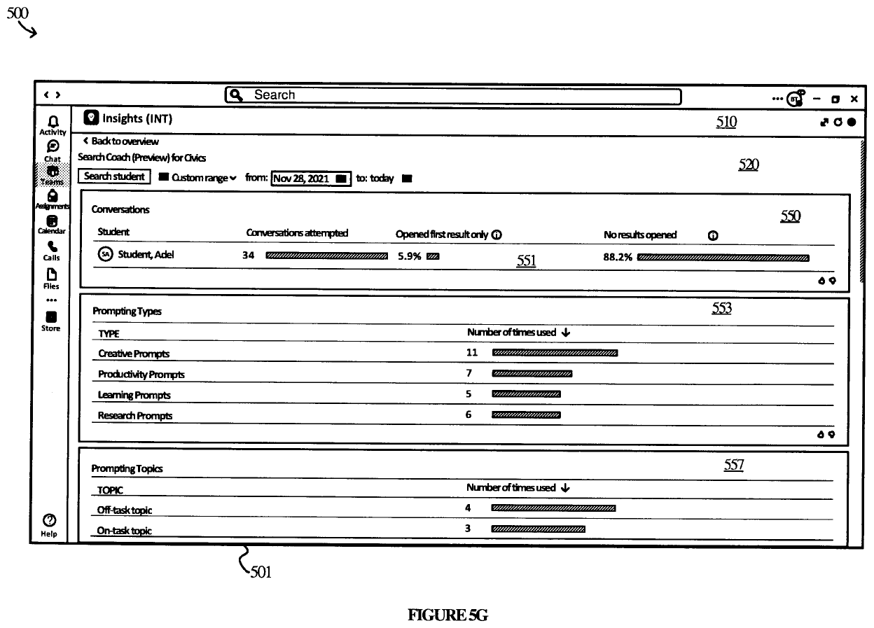

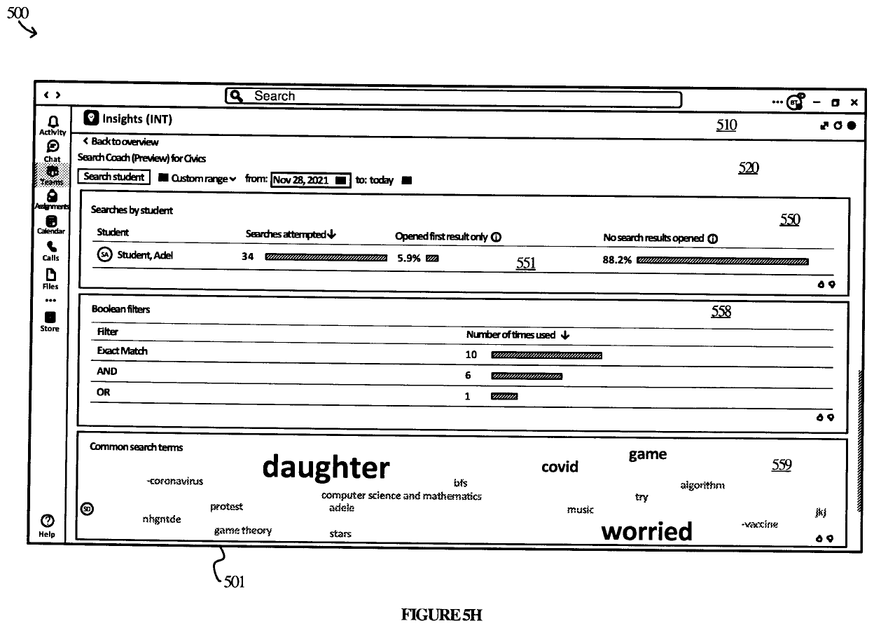

Turning now to the examples provided in FIGS. 5A-5H, FIGS. 5A-5H illustrate a user experience 500 in an education-based scenario to demonstrate various facets of the search engine insights disclosed herein, although it may be appreciated that the concepts apply as well to other settings, situations, and scenarios.

Referring to FIG. 5A, user experience 500 illustrates a user interface 501 generated and displayed on a computing device (e.g., computing device 415 operated by user C). User interface 501 includes components associated with a collaboration application (e.g., collaboration application 421 in FIG. 4) including components 503, 505, 509, and 507. Component 503 is representative of a main title bar that allows a reviewing user to open, close, minimize, or maximize user interface 501. Component 503 includes a search box 504 via which a user may input search queries with respect to content in the collaboration application such as documents, contacts, and other material.

Component 505 is representative of a feature bar that includes various icons for accessing modules of the application. For instance, component 505 includes an activity icon for checking alerts or reminders, a chat icon for chatting with other users, an icon for accessing team-oriented flows, an assignments icon for posting and reviewing assignments, a calendar icon for accessing a calendar feature, a call icon for placing voice calls, a files icon for managing files, and a store icon for accessing an app store. In some implementations, component 505 may include an icon for accessing an insights module, an insights add-in application, or the like.

The app store-accessible via the store icon-provides the user with the ability to download and install “add-in” applications that are integrated into the context of the main application. Here, it is assumed for exemplary purposes that the user has installed an insights application through the store (or by some other mechanism). In other scenarios, the insights application may be part of another application, such as a collaboration application. The insights application is akin to search application 423, in that it is loaded and executed in the context of another application. Thus, user interface 501 also includes various components associated with the insights application such as components 510-511. As mentioned, the insights application may be launched from an icon in component 505. Alternatively, the insights application may be launched from an icon or button in component 505. In still other implementations, the insights application may be provided as a feature of existing functionality of the collaboration application.

Component 510 is representative of a title bar that identifies the insights application and allows the reviewing user to expand, shrink, and refresh the add-in application. Component 511 is representative of a display frame through which recent and/or highlighted information about a group may be surfaced. Here, it is assumed for exemplary purposes that the insights application is being used to observe the progress of eleven (11) students who are using corresponding student versions of the insights application to conduct Internet searches and engage in prompt-based conversations with AI-powered chatbots. Student internet searches and prompting are captured by a prompt coach service (e.g., prompt coach service 401) and reported to an insights service (e.g., insights service 410). In turn, the insights service develops insights on a per-user basis and feeds those insights to a computing device (e.g., computing device 415) to be surface in a user interface, such as that illustrated herein with respect to FIGS. 5A-5G.

Continuing with user experience 500, component 513 in FIG. 5A is representative of another display frame in which user activity over a certain time period, e.g., in the past week, is reported. The reviewing user may click into component 515 to view details of user activity in the past week. Similarly, component 517 is a display frame that indicates user activity over another time period, e.g., in the past 28 days. The reviewing user may click into component 519 to navigate to a detailed view of user activity for the past 28 days, which is illustrated in FIG. 5B.

User experience 500 in FIGS. 5B-5F includes detailed usage information and insights associated with the search and prompting history of the members of the target group. In FIG. 5B, user interface 501 has transitioned to include component 520, which is representative of a display frame in which prompting insights for individuals of the group may be surfaced. Component 520 includes a calendar component 522 for configuring the timeframe in which prompting histories and insights are displayed. Here, the timeframe ranges from Nov. 28, 2021, to the present.

Component 521 is a display frame in which the insights are surfaced for each observed user. The insights include various metrics such as the number of conversations attempted by each observed user, the percentage of conversations where only the first result or link in a reply from a chatbot was opened, and the percentage of replies from a chatbot where no results were opened at all. A reviewing user may change the date range via calendar component 522 to obtain insight(s) into the progression of the observed users with respect to searching. For example, early in the user's history, the prompting and resulting conversations may be low quality, leading to a high percentage where none of the content or links in replies were leveraged by an observed user. Later in the user's history (more recently), as user proficiency has increased, the number of replies resulting in zero click-throughs may decline.

In addition to the statistics shown in component 521, a reviewing user may scroll down to access component 523 and component 527 shown in FIG. 5C. Component 523 includes insights related to different types of prompts used in conversation with an LLM engine. In particular, component 523 displays the number of prompts classified as belonging to a specific category of prompting types including a creative type, a productivity type, a learning type, and a research type. As with component 521, the reviewing user may filter the type-related insights by adjusting the date range in calendar component 522. In some cases, a user may select a bar 529 on component 523 to view examples of prompts that are classified into a specific category.

Component 527 illustrates insights pertaining to the topics of prompts used in conversation with an LLM engine. For instance, component 527 displays the number of prompts classified as belonging to a specific category of prompting topics including off-task topics, on-task topics, inappropriate topics, and appropriate topics. The reviewing user may also filter the topic-related insights by adjusting the date range in calendar component 522.

As shown in FIG. 5D, the reviewing user may scroll down even further to view components 531 and 535. Component 531 is representative of a display frame in which insights related to prompting quality are displayed. Here, a count is displayed indicative of the number of prompts classified as belonging to a specific category of prompting quality including high-quality, moderate quality, low-quality, and very poor quality.

Component 535 is representative of a display frame in which insights related to specific domains are displayed. Here, a count is displayed indicative of the number of times the observed users visited specific domains returned in the replies by an AI chatbot. For example, a prompt generated by a student may elicit a reply that includes a link to a website. The domain referenced by the link may be tracked, as well as whether the student subsequently clicked on the link and visited the website. As with the other display components, the reviewing user may filter the insights using calendar component 522.

Component 537 in FIG. 5E is representative of a display frame in which a word cloud may be displayed. The word cloud is indicative of the prompt terms used by the observed users over a particular period of time. The larger the word, the more frequently the word was used as a prompt term. The reviewing user may adjust the period over which the word cloud is constructed by adjusting the dates in calendar component 522. Upon selection of a displayed term, a count of prompts that included the term may be displayed. For example, here the reviewer has clicked on the term “Microsoft,” causing a count of “18” to be displayed. In addition, if a reviewer selects a term, they may also be presented with the specific prompts that include the term.

In FIG. 5F, the reviewing user desires to drill-down into prompt insights for a specific student. The reviewing user does so via component 541, which is representative of a drop-down menu in which the reviewing user may select the name of a specific student. Here, it is assumed for exemplary purposes that the reviewing user selects Adel. Accordingly, user experience 500 transitions to a state illustrated in FIG. 5G whereby prompt insights are provided for Adel.

In FIGS. 5G-H, user interface 501 includes component 550, which is a display frame in which high-level prompt metrics are provided on a per-user basis (e.g., for Adel). For example, component 550 displays the number of prompting conversations (34) conducted by Adel during a time period defined by calendar component 522. Component 550 also identifies the number or percentage of prompts (5.9%) that elicited replies with content that was opened by Adel, as well as the number or percentage of prompts (88.2%) that elicited replies where no content was opened by Adel.

Further down, component 553 displays user-specific insights related to different types of prompts used in conversation with an LLM engine. For example, component 553 displays the number of prompts classified as belonging to specific categories of prompting types. In addition, component 557 displays the number of prompts classified as belonging to specific categories of prompting topics on a user-specific basis.

The reviewing user may scroll down further in the user interface to component 557, which details insights at a granular level with respect to domain visits. Here, a count is displayed indicative of the number of times the observed user visited specific domains returned in the replies by an AI chatbot. Further down in FIG. 5H, the user is presented with component 559, which is a word cloud that shows the prevalence of various words in the prompt terms used by the student over a period of time. As with the preceding examples, the reviewing user may adjust the time period under review via calendar component 522, in response to which the insights in the various display components change to reflect usage during the updated time period. For example, the reviewing user may advance forward or move backward in time to ascertain how the target student's prompting ability has progressed (or regressed) over time.

Turning now to FIG. 6, FIG. 6 illustrates computing device 601 that is representative of any system or collection of systems in which the various processes, programs, services, and scenarios disclosed herein may be implemented. Examples of computing device 601 include, but are not limited to, desktop and laptop computers, tablet computers, mobile computers, mobile phones, and wearable devices. Examples may also include server computers, web servers, cloud computing platforms, and data center equipment, as well as any other type of physical or virtual server machine, container, and any variation or combination thereof.

Computing device 601 may be implemented as a single apparatus, system, or device or may be implemented in a distributed manner as multiple apparatuses, systems, or devices. Computing device 601 includes, but is not limited to, processing system 602, storage system 603, software 605, communication interface system 607, and user interface system 609 (optional). Processing system 602 is operatively coupled with storage system 603, communication interface system 607, and user interface system 609.

Processing system 602 loads and executes software 605 from storage system 603. Software 605 includes and implements insights process 606, which is representative of insights processes discussed with respect to the preceding Figures, such as insights process 200. When executed by processing system 602, software 605 directs processing system 602 to operate as described herein for at least the various processes, operational scenarios, and sequences discussed in the foregoing implementations. Computing device 601 may optionally include additional devices, features, or functionality not discussed for purposes of brevity.

Referring still to FIG. 6, processing system 602 may comprise a micro-processor and other circuitry that retrieves and executes software 605 from storage system 603. Processing system 602 may be implemented within a single processing device but may also be distributed across multiple processing devices or sub-systems that cooperate in executing program instructions. Examples of processing system 602 include general purpose central processing units, graphical processing units, application specific processors, and logic devices, as well as any other type of processing device, combinations, or variations thereof.

Storage system 603 may comprise any computer readable storage media readable by processing system 602 and capable of storing software 605. Storage system 603 may include volatile and nonvolatile, removable and non-removable media implemented in any method or technology for storage of information, such as computer readable instructions, data structures, program modules, or other data. Examples of storage media include random access memory, read only memory, magnetic disks, optical disks, flash memory, virtual memory and non-virtual memory, magnetic cassettes, magnetic tape, magnetic disk storage or other magnetic storage devices, or any other suitable storage media. In no case is the computer readable storage media a propagated signal.

In addition to computer readable storage media, in some implementations storage system 603 may also include computer readable communication media over which at least some of software 605 may be communicated internally or externally. Storage system 603 may be implemented as a single storage device but may also be implemented across multiple storage devices or sub-systems co-located or distributed relative to each other. Storage system 603 may comprise additional elements, such as a controller capable of communicating with processing system 602 or possibly other systems.

Software 605 (including insights process 606) may be implemented in program instructions and among other functions may, when executed by processing system 602, direct processing system 602 to operate as described with respect to the various operational scenarios, sequences, and processes illustrated herein. For example, software 605 may include program instructions for implementing an insights process as described herein.

In particular, the program instructions may include various components or modules that cooperate or otherwise interact to carry out the various processes and operational scenarios described herein. The various components or modules may be embodied in compiled or interpreted instructions, or in some other variation or combination of instructions. The various components or modules may be executed in a synchronous or asynchronous manner, serially or in parallel, in a single threaded environment or multi-threaded, or in accordance with any other suitable execution paradigm, variation, or combination thereof. Software 605 may include additional processes, programs, or components, such as operating system software, virtualization software, or other application software. Software 605 may also comprise firmware or some other form of machine-readable processing instructions executable by processing system 602.

In general, software 605 may, when loaded into processing system 602 and executed, transform a suitable apparatus, system, or device (of which computing device 601 is representative) overall from a general-purpose computing system into a special-purpose computing system customized to support insights features, functionality, and user experiences. Indeed, encoding software 605 on storage system 603 may transform the physical structure of storage system 603. The specific transformation of the physical structure may depend on various factors in different implementations of this description. Examples of such factors may include, but are not limited to, the technology used to implement the storage media of storage system 603 and whether the computer-storage media are characterized as primary or secondary storage, as well as other factors.

For example, if the computer readable storage media are implemented as semiconductor-based memory, software 605 may transform the physical state of the semiconductor memory when the program instructions are encoded therein, such as by transforming the state of transistors, capacitors, or other discrete circuit elements constituting the semiconductor memory. A similar transformation may occur with respect to magnetic or optical media. Other transformations of physical media are possible without departing from the scope of the present description, with the foregoing examples provided only to facilitate the present discussion.

Communication interface system 607 may include communication connections and devices that allow for communication with other computing systems (not shown) over communication networks (not shown). Examples of connections and devices that together allow for inter-system communication may include network interface cards, antennas, power amplifiers, RF circuitry, transceivers, and other communication circuitry. The connections and devices may communicate over communication media to exchange communications with other computing systems or networks of systems, such as metal, glass, air, or any other suitable communication media. The aforementioned media, connections, and devices are well known and need not be discussed at length here.

Communication between computing device 601 and other computing systems (not shown), may occur over a communication network or networks and in accordance with various communication protocols, combinations of protocols, or variations thereof. Examples include intranets, internets, the Internet, local area networks, wide area networks, wireless networks, wired networks, virtual networks, software defined networks, data center buses and backplanes, or any other type of network, combination of network, or variation thereof. The aforementioned communication networks and protocols are well known and need not be discussed at length here.

As will be appreciated by one skilled in the art, aspects of the present invention may be embodied as a system, method or computer program product. Accordingly, aspects of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, aspects of the present invention may take the form of a computer program product embodied in one or more computer readable medium(s) having computer readable program code embodied thereon.

It may be appreciated that, while the inventive concepts disclosed herein are discussed in the context of insights applications and services, they apply as well to other contexts such as productivity applications and services, gaming applications and services, virtual and augmented reality applications and services, business applications and services, and other types of software applications, services, and environments.

Indeed, the included descriptions and figures depict specific embodiments to teach those skilled in the art how to make and use the best mode. For the purpose of teaching inventive principles, some conventional aspects have been simplified or omitted. Those skilled in the art will appreciate variations from these embodiments that fall within the scope of the disclosure. Those skilled in the art will also appreciate that the features described above may be combined in various ways to form multiple embodiments. As a result, the invention is not limited to the specific embodiments described above, but only by the claims and their equivalents.

What is claimed is:

1. A method of operating an insights service, the method comprising:
observing, by an insights service, prompting associated with a large language model service, wherein the observation is performed on a per-user basis with respect to each user in a group of observed users;
identifying, by the insights service, insights into the prompting on the per-user basis with respect to each of the group of observed users; and
enabling, by the insights service, display of the insights in a user interface associated with a reviewing user.

2. The method of claim 1 wherein observing, by the insights service, the prompting comprises:
observing, by the insights service, prompts submitted to the large language model service;
observing, by the insights service, replies to the prompts from the large language model service; and
observing, by the insights service, user actions with respect to the replies.

3. The method of claim 2 further comprising:
organizing, by the insights service, the prompting into conversations;
classifying, by the insights service, each of the conversations as belonging to one or more of a set of categories based at least on characteristics of the prompts, characteristics of the replies, and characteristics of the user actions; and
identifying, by the insights service, trends with respect to the set of categories.

4. The method of claim 3, wherein the categories comprise a subset of categories associated with prompting types, the subset of categories comprising a creative category, a productivity category, a learning category, and a research category.

5. The method of claim 3, wherein the categories comprise a subset of categories associated with prompting topics, the subset of categories comprising an off-task category, an on-task category, and an inappropriate content category.

6. The method of claim 3, wherein the categories comprise a subset of categories associated with prompting quality, the subset of categories comprising a high-quality category and a low-quality category.

7. The method of claim 3, wherein the categories comprise:
a first subset of categories associated with prompting types, wherein the first subset of categories comprises a creative category, a productivity category, a learning category, and a research category;
a second subset of categories associated with prompting topics, wherein the second subset of categories comprises an off-task category, an on-task category, and an inappropriate content category; and
a third subset of categories associated with prompting quality, wherein the third subset of categories comprises a high-quality category and a low-quality category.

8. The method of claim 3, wherein:
the characteristics of the prompts comprises content of the prompts;
the characteristics of the replies comprises content of the replies; and
the characteristics of the user actions comprises dwell time over the replies, a frequency of using a stop-replying feature with respect to the replies, and a frequency of click-throughs with respect to the content in the replies.

9. A computing apparatus comprising:
one or more computer readable storage media;
one or more processors operatively coupled with the one or more computer readable storage media; and
an application comprising program instructions stored on the one or more computer readable storage media that, when executed by the one or more processors, direct the computing apparatus to at least:
communicate with an insights service to obtain, on a per-user basis with respect to each user of a group of observed users, insights into prompting associated with a large language model service; and
display a view of the insights in a user interface to the application.

10. The computing apparatus of claim 9, wherein the insights comprise trends identified in the prompting based on observations by the insights service of the prompting.

11. The computing apparatus of claim 10, wherein the observations comprise:
observations of prompts submitted to the large language model service;
observations of replies to the prompts from the large language model service; and
observations of user actions with respect to the replies.

12. The computing apparatus of claim 11, wherein the insights service:
organizes the prompting into conversations;
classifies each of the conversations as belonging to one or more of a set of categories based at least on:
characteristics of the prompts;
characteristics of the replies; and
characteristics of the user actions; and
identifies the trends with respect to the set of categories.

13. The computing apparatus of claim 12, wherein the set of categories comprises:
a first subset of categories associated with prompting types, the first subset of categories comprising a creative category, a productivity category, a learning category, and a research category;
a second subset of categories associated with prompting topics, the second subset of categories comprising an off-task category, an on-task category, and an inappropriate content category; and
a third subset of categories associated with prompting quality, the third subset of categories comprising a high-quality category and a low-quality category.

14. The computing apparatus of claim 13, wherein:
the characteristics of the prompts comprises content of the prompts;
the characteristics of the replies comprises content of the replies; and
the characteristics of the user actions comprises dwell time over the replies, a frequency of using a stop-replying feature with respect to the replies, and a frequency of click-throughs with respect to the content in the replies.

15. One or more computer readable media having program instructions stored thereon for operating an insights service that, when executed by one or more processors of one or more computing devices, direct the one or more computing devices to at least:
observe prompting associated with a large language model service on a per-user basis with respect to each user in a group of observed users,
identify insights into the prompting on the per-user basis with respect to each of the group of observed users; and
enable display of the insights in a user interface associated with a reviewing user.

16. The one or more computer readable media of claim 15, wherein, to observe the prompting, the program instructions direct the one or more computing devices to at least:
observe prompts submitted to the large language model service;
observe replies to the prompts from the large language model service; and
observe user actions with respect to the replies.

17. The one or more computer readable media of claim 16, wherein the program instructions further direct the one or more computing devices to at least:
organize the prompting into conversations;
classify each of the conversations as belonging to one or more of a set of categories based at least on:
characteristics of the prompts;
characteristics of the replies; and
characteristics of the user actions; and
identify trends with respect to the set of categories.

18. The one or more computer readable media of claim 17, wherein the set of categories comprises a subset of categories associated with prompting types, the subset of categories comprising a creative category, a productivity category, a learning category, and a research category.

19. The one or more computer readable media of claim 17, wherein the set of categories comprises a subset of categories associated with prompting topics, the subset of categories comprising an off-task category, an on-task category, and an inappropriate content category.

20. The one or more computer readable media of claim 17, wherein the set of categories comprises a subset of categories associated with prompting quality, the subset of categories comprising a high-quality category and a low-quality category.
